(19) United States
(12) Patent Application Publication
(10) Pub. No.: US 2026/0111886 A1
(43) Pub. Date: Apr. 23, 2026

(54) PRIVACY FOR A CROSS-CHAIN INTEROPERABILITY PROTOCOL

(71) Applicant: SmartContract Chainlink Limited SEZC, Grand Cayman (KY)

(72) Inventors: Gregory Neven, Grand Cayman (KY); Alex Coventry, Grand Cayman (KY)

(73) Assignee: SmartContract Chainlink Limited SEZC, Grand Cayman (KY)

(21) Appl. No.: 19/361,946

(22) Filed: Oct. 17, 2025

Related U.S. Application Data
(60) Provisional application No. 63/709,166, filed on Oct. 18, 2024.

(51) Int. Cl. G06Q 20/38; G06Q 20/40

(52) U.S. Cl. CPC G06Q 20/3829; G06Q 20/38215; G06Q 20/401

(57) ABSTRACT

Systems, devices, and methods for cross-chain interoperability protocol privacy are disclosed for privately transferring cross-chain transactions from a source chain to a destination chain. Transfer of information and/or assets between blockchains is encrypted and decrypted, leading to improved functionality and privacy for each respective chain.

### CROSS-REFERENCE TO RELATED APPLICATION

This application claims priority to and the benefit of U.S. Provisional Patent Application No. 63/709,166 filed on Oct. 18, 2024 entitled “PRIVACY FOR A CROSS-CHAIN INTEROPERABILITY PROTOCOL.” The disclosure of the foregoing application is incorporated herein by reference, except for any subject matter disclaimers or disavowals, and except to the extent of any conflict with the disclosure of the present application, in which case the disclosure of the present application shall control.

### TECHNICAL FIELD

This disclosure is in the field of distributed systems, and in particular the field of privacy in transferring data using blockchain and distributed network computing.

### BACKGROUND

Prior approaches for processing data using a blockchain system have suffered from various limitations, for example limitations related to interoperability and privacy of transfer of data or information across multiple blockchains. As the number of blockchains grows, people and applications are looking for ways to best make use of new chains and their features. There is a need for programs which transfer data with privacy across blockchains and interoperability among systems. Accordingly, systems and methods offering improvements thereto remain highly desirable.

### BRIEF DESCRIPTION OF THE DRAWINGS

The accompanying drawings are included to provide a further understanding of the present disclosure and are incorporated in, and constitute a part of, this specification, illustrate various exemplary embodiments, and together with the description, serve to explain exemplary principles of the disclosure.

FIG. 1 illustrates a cross-chain interoperability protocol privacy system, in accordance with various exemplary embodiments;

FIG. 2A illustrates a graphical description of an authenticated encryption scheme, in accordance with various embodiments;

FIG. 2B illustrates a graphical description of an authenticated encryption scheme, in accordance with various embodiments; and

FIG. 2C illustrates a graphical description of an authenticated encryption scheme, in accordance with various embodiments.

### DETAILED DESCRIPTION

The detailed description of various exemplary embodiments herein makes reference to the accompanying drawings, which show various exemplary embodiments by way of illustration. While these various exemplary embodiments are described in sufficient detail to enable those skilled in the art to practice the disclosure, it should be understood that other embodiments may be realized and that structural, logical, and/or similar changes may be made without departing from the spirit and scope of the disclosure. Thus, the detailed description herein is presented for purposes of illustration and not of limitation.

For example, steps recited in any of the method or process descriptions may be executed in any suitable order and are not necessarily limited to the order presented. Furthermore, any reference to singular may include plural embodiments, and any reference to more than one component or step may include a singular embodiment or step.

This disclosure relates generally to systems, devices, and methods for cross-chain privacy. In various embodiments, a connection across multiple blockchains may be referred to as a “bridge.” When transferring or transacting across bridges, there is a need to improve security and privacy. Prior designs failed to properly secure data transmitted across multiple blockchains and verify accuracy. Further, previous systems fail to encrypt transactions and securely decrypt transactions. In various embodiments, exemplary cross-chain privacy systems as disclosed herein comprise secure security critical structure and code.

In various exemplary embodiments, systems, devices, and methods for cross-chain interoperability may utilize a Cross-Chain Interoperability Protocol (CCIP) for implementing capabilities and/or principles discussed herein. In various exemplary embodiments, a cross-chain interoperability system may provide a universal, open standard for developers to build secure services and applications that can send messages, transfer tokens, and initiate actions across multiple blockchains. The cross-chain interoperability protocol privacy system may send a cross chain message from a source chain to a destination chain. In various embodiments, the term “chain” may be used in reference to a blockchain, or suitable chain of data recorded in blocks. In various exemplary embodiments, the cross-chain message may comprise a receiver address, a message data, a token, and/or a fee token. The receiver address may comprise the address of the receiver on the destination chain. The message data may comprise bytes of data being sent to the receiver. The token may comprise token amounts and/or type to be sent to a blockchain. For example, the token may, in various exemplary embodiments, comprise a token such as “ERC20” tokens to be sent to Ethereum Virtual Machine (EVM) source chains, or any suitable crypto currency compatible with a blockchain.

In various exemplary embodiments, a cross-chain message, such as a transaction or event, may be sent with one or more steps. For example, a Decentralized Oracle Network (DON) may facilitate the CCIP of the cross-chain interoperability system. The DON may facilitate the CCIP of the cross-chain interoperability system with a committing DON and/or an execution DON, for example. The committing DON may be responsible for determining an attested root based on the cross-chain message, such as the encrypted transaction. In various exemplary embodiments, an execution DON may be responsible for delivering the cross-chain message to the final receiver. In various exemplary embodiments, an execution DON may correspond to the OnRamp and OffRamp pair. In various exemplary embodiments, the system may comprise one or more DONs, also referred to as cross-chain processing systems, running in parallel. In various exemplary embodiments, each cross-chain processing system may correspond to a specific destination blockchain. The cross-chain processing system may be configured to send transactions to the destination chain. The cross-chain interoperability system may determine the cross-chain processing system to send a cross-chain message to a destination chain.

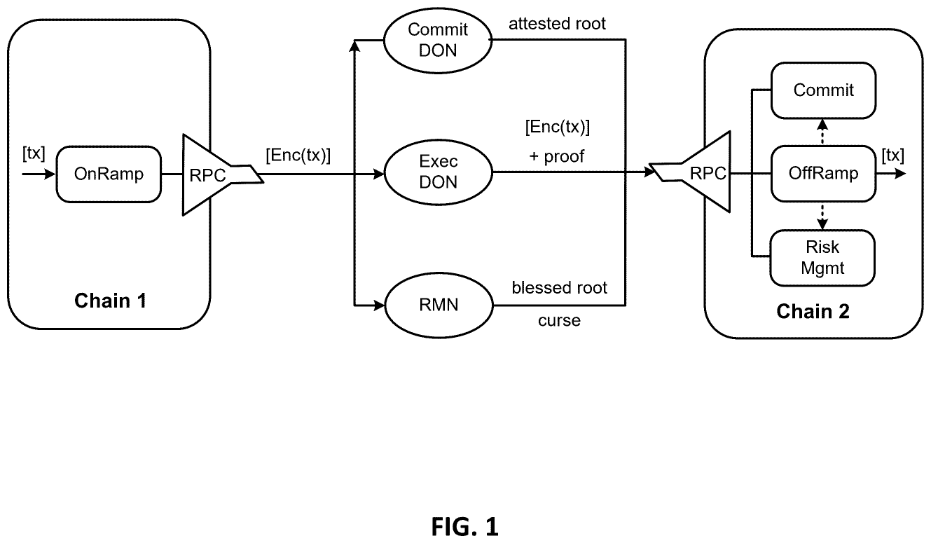

With reference now to FIG. 1, systems, devices, and methods for cross-chain interoperability protocol privacy are shown in accordance with various embodiments. A cross-chain interoperability protocol privacy system, also referred to as the CCIP privacy system, may comprise a first public or private chain (Chain 1), a decentralized oracle network (DON), and a second public or private chain (Chain 2). The system may comprise methods of encrypting transactions on a source chain and decrypting transactions on a destination chain. The decryption by the destination chain may comprise verification of an attested root and proof based on the encrypted transaction, as discussed herein.

The first chain, Chain 1, may comprise a public or private blockchain. A Remote Procedure Call (RPC) node may comprise an RPC filter policy set so nodes in Committing DON, Executing DON, and/or Risk Management Network (RMN) only have read access to (encrypted) events emitted by OnRamp contract. For example, the OnRamp may receive a transaction ([tx]), encrypt the transaction and provide the encrypted transaction to the RPC. The RPC may provide an encrypted transaction ([ENC (tx)]), such as an encrypted event, to Committing DON, Executing DON, and/or Risk Management Network (RMN).

In various exemplary embodiments, the Committing DON, Executing DON, and/or RMN may talk to multiple RPC nodes and compare results, to increase reliability and integrity. For example, utilizing a single RPC node means trusting the single RPC node is always online and not tampering with the data; therefore, use of multiple RPC nodes may improve accuracy and tamper resistance.

In various exemplary embodiments, the OnRamp contract may receive a cleartext transaction and encrypts the cleartext transaction by one or more of the following methods: (a) encrypting under the public key of Chain 2; (2) encrypting under a symmetric key out-of-band agreed between Chain 1 and Chain 2; (c) or encrypting under a symmetric key derived from the public keys of Chain 1 and Chain 2, (e.g., Diffie-Hellman key derivation K=H(g^{xy}) for pk₁=g^{x} and pk₂=g^{y}). In various exemplary embodiments, the choice of encryption scheme may depend on the gas costs of various operations on both chains. The encryption keys and randomness for encryption can be provided by (private) transactions to the OnRamp contract.

In various exemplary embodiments, the Committing DON, Executing DON, and RMN may each use the encrypted payload of transactions instead of the cleartext transactions. In various exemplary embodiments, the Committing DON, the Executing DON, and/or the RMN may be public.

The Committing DON may obtain encrypted transactions through the Chain 1 RPC. The Committing DON may batch encrypted transactions. The Committing DON may compute one or more Merkle roots based on the encrypted transactions. The Committing DON may treat transactions as opaque binary blobs. The Committing DON may attest a Merkle root and send the attested root to the Commit Store contract (Commit) on Chain 2 via the Chain 2 RPC.

The Executing DON may obtain encrypted transactions through Chain 1 RPC. The Executing DON may read attested roots from the Commit contract on Chain 2 through Chain 2 RPC. The Executing DON may submit individual or multiple encrypted transactions with the associated Merkle proofs to the OffRamp contract on Chain 2 through Chain 2 RPC.

The RMN may obtain encrypted transactions through Chain 1 RPC and monitors their finality. The RMN may batch encrypted transactions and compute Merkle roots over them, treating transactions as opaque binary blobs. The RMN may send a Merkle root to Risk Management contract on Chain 2 via Chain 2 RPC. The RMN may read OffRamp events for transaction executions. Upon execution of a transaction, the OffRamp may emit an event containing the encrypted transaction (or a hash of the encrypted transaction) to the RMN, such that the transaction details are private to the RMN. The RMN may send curses to the Risk Management contract on Chain 2 via Chain 2 RPC, in case anomalous activity is identified.

Chain 2 may comprise an RPC filter set. The Committing DON, Executing DON, and RMN nodes may comprise or be configured with write access to the Commit Store, OffRamp, and Risk Management contracts, respectively. The Executing DON and RMN nodes may comprise or be configured with read access to Commit Store and OffRamp Contracts. The OffRamp contract may verify Merkle proofs for encrypted transactions submitted by Executing DON against attested and blessed roots from Commit Store and Risk Management contracts. After successful Merkle proof verification, the OffRamp contract may decrypt encrypted transactions and process the encrypted transaction. The decryption key may be provided by a (private) transaction to the OffRamp contract.

In various exemplary embodiments, the transaction encryption may alternatively be performed by the RPC (e.g., through plugin), by a proxy node, or by additional component(s) (not shown) after the RPC. For example, the RPC of Chain 1 may comprise a plugin for encrypting the cleartext transaction. The Chain 2 OffRamp may receive a cleartext transaction and encrypted transactions, though, as Merkle root/proofs are over encrypted transactions. The correct decryption may be certified by signature by the component that performed the decryption of the encrypted transaction. Alternatively, in various embodiments, the OffRamp may be given the decryption key to re-decrypt the encrypted transaction.

In various exemplary embodiments, an exemplary CCIP privacy system may comprise encryption of the transaction by one or more proxy nodes. For example, a proxy node may encrypt the clear-text transaction of Chain 1. The proxy node may restrict the oracle nodes of the DON to view the encrypted transaction rather than the cleartext transaction. The DON may provide the encrypted transaction to one or more proxy node machines associated with Chain 2 that restrict the oracle nodes' view of Chain 2 to the execution status of encrypted transactions provided by the oracle nodes. The proxy node may read a cleartext transaction of Chain 1 and encrypt the transaction based on an encryption key. Further, a proxy node machine associated with Chain 2 may receive the encrypted transaction and decrypt the transaction based on a decryption key. The encryption key used by the proxy nodes of Chain 1 and the decryption key used by the proxy node of Chain 2 may be the same symmetric encryption key. The encryption key used by the proxy nodes of Chain 1 may consist of one or more public encryption keys, the private decryption keys of which are held by the proxy nodes of Chain 2.

In various exemplary embodiments, CCIP transfer between blockchains may comprise filtering of the blockchains' JSON-RPC endpoints. Filtering of the RPC endpoints may ensure that the CCIP DON can only send and receive information pertinent to the correct operation of CCIP. Some blockchains have sufficiently powerful built-in access controls for this filtering. However, in various exemplary embodiments, the CCIP privacy system may comprise a filtering proxy in front of the RPC endpoints. Because this offchain proxy system is often present, it allows for encryption and decryption of CCIP messages to be done offchain, by the proxies. The CCIP DON remains oblivious to the message contents, and this approach renders the bespoke onchain encryption/decryption unnecessary, which increases data security, and increases the likelihood of adherence to FIPS-compliant standards, for instance.

### Multiple JSON-RPC Proxies

In various exemplary embodiments, an exemplary CCIP privacy system may comprise a single JSON-RPC proxy. In various exemplary embodiments, an exemplary CCIP privacy system may comprise proxies to multiple JSON-RPC endpoints in communication with client organizations, and DON nodes connecting to different proxies, for the sake of decentralization of responsibilities within the client organizations.

Multiple proxies may complicate the cryptography slightly, because core encryption properties like IND-CPA depend on randomized algorithms. Therefore, the nodes may share and specify the randomness used for encryption, in order for all of the nodes to send the same ciphertexts to the CCIP DON. Alternatively, the DON may wait on 2f+1 encryptions of a message, and send all of the encryptions of the message to the destination blockchain. Relying on the proxies to send identical ciphertexts is not as prone to split views among the proxies, because only the messages may be encrypted (as with the onchain encryption solution) as individual plaintexts, so the order in which the proxies see the messages in their view does not affect the ciphertexts. To ensure an adequate approximation to IND-CCA, it will suffice for the randomness of the encryption scheme to be derived from the blockhash prior to the block in which a message is received by the on-ramp, an extra key, and the message itself. However, any suitable approach may be followed, as desired.

The use of specific entropy sources for the RNG provided to encryption services may limit the encryption libraries system users are able to use within the proxies to those which provide an API which allows the user to specify the RNG to use. Many libraries allow specification of the randomness, such as chacha20poly 1305 (golang, as used in age), aes. GCM (golang), and aes_gcm (rust), but taking on responsibility for providing secure randomness by excluding it from the external API of a library may be implemented as a common misuse-prevention measure.

### Architectural Overview

The source chain and destination onchain of the CCIP privacy system may share a key, k such as an HMAC key. Each proxy i to source chain's JSON-RPC endpoints may have a signing key ski with public key spkᵢ. Each of the destination chain proxies may share a decryption key dk with public key epk. The destination chain proxies may know the public transmitter keys of the CCIP DON, so that they can verify that messages they receive from the DON are endorsed by a quorum of DON nodes. There may be a fault-tolerance factor f on the committee of source nodes. This may differ from the corresponding tolerance factor on the DON committee. The destination chain proxies may also have ethereum/blockchain keys which the destination OffRamp OCR system recognizes as a transmitter address.

### Design Using Coordinated Randomness

In various exemplary embodiments, the source proxies may also share a randomness key rk, so that they generate identical pseudorandom inputs to randomized cryptographic functions, and thereby produce identical ciphertexts/signatures. As a further defense of key material, it would also be possible to source this randomness from a random beacon maintained by the source proxies operating in concert.

The workflow using coordinated randomness (Happy Path) may comprise the following steps, for example:
1. User makes a CCIP Send request r on the source chain. CCIP emits an event log with the request and HMAC(k, r).
2. When the CCIP DON requests such logs or they are published by a websocket subscription, the sending proxy i intercepts the log and encrypts any EVM2EVMMessage it contains by first constructing a PRNG rng from the plaintext message, the hash of the block containing the message, the nonce on the log, the sender, and the randomness key rk, and encrypting using rng. (The purpose of mixing rk with these extra factors is to minimize the likelihood of deriving the same seed for different messages, ideally preserving CPA indistinguishability even if the sender provides identical plaintexts.)
3. The source proxy sends the log adjusted to include the encrypted message to the CCIP DON, as if it were part of the JSON-RPC response to an eth_getLogs or a logs subscription. (Here we are exploiting the fact that there is no cryptographic verification that JSON-RPC responses actually reflect blockchain state.)
4. The CCIP DON processes the log and passes it to the destination blockchain with its usual quorum of DON signatures (in this system, no Merkle verification is done), once it has received a quorum of reports containing the log from the sending RPC proxies the DON can assess quorum by counting occurrences of identical logs until it reaches quorum threshold f+1.
5. The CCIP DON includes the sending proxies' signatures on the log (with ciphertext) it sends to the destination proxies.
6. The receiving proxy verifies the DON signatures, and identifies that an eth sendRawTransaction has been requested, and notes that it's destined for the OffRamp's transmit method.
7. It parses out the encrypted message, verifies the sending signatures on the ciphertext against {spki}i, and decrypts it. If those signatures are valid and meet the quorum threshold, it creates a new transmit transaction with the decrypted message (including the KMAC), signs it with its transmitter key so that it's again a valid ethereum transaction, and sends it to the destination chain.
8. The destination OffRamp checks the KMAC on the received message, and processes the message as usual.
   Design without Coordinated Randomness

In various exemplary embodiments, client-supplied randomness in their encryption API may not be used for any number of reasons, the randomness key rk cannot be used to ensure that the source proxies generate identical ciphertexts for a given request. In that case, the happy-path workflow is similar to the above except that for the following, for example:

In step 2, rng is not calculated, and the source proxies will likely generate different ciphertexts for the same message. Therefore, the OnRamp maintains a strictly-increasing counter, the current value of which it sends as part of the ciphertext.

In step 4, the DON waits for a quorum of 2f+1 messages (instead of f+1) before transmitting to the source proxies, and sends all the ciphertexts for a given message. It aggregates ciphertexts based on the counter value just mentioned, the address of the emitting contract, and the hash of the block in which the log was emitted. (It cannot aggregate on the basis of the ciphertexts themselves in this case, because they'll differ from proxy to proxy.)

In step 7, the source proxy keeps decrypting the 2f+1 messages just mentioned until it recovers f+1 identical plaintexts, then proceeds with that common plaintext.

### Pros and Cons of the Two Approaches

The advantage of the coordinated-randomness approach is that it's more efficient, allowing the DON to await a quorum of only f+1 messages, and allowing the source proxies to decrypt a single ciphertext per message. One disadvantage is that the sending proxies share a common randomness key rk, which increases the risk of the key leaking. This could be mitigated by having the source proxies maintain a random beacon. The main disadvantage of the coordinated-randomness approach, and the one which motivated the proposal of the alternative, is that it requires an encryption API which allows for client-specified randomness.

Thus, the main advantage of the second approach is flexibility about the encryption used by the source proxies, and the main disadvantage is the extra communication- and computational-complexity. It's arguably a little more difficult to reason about as a distributed system, compared to the coordinate-randomness option.

### Encryption Overview

In various embodiments, the transaction may be encrypted using various algorithms, including hash-based authenticated encryption. The hash-based authenticated encryption may comprise a nonce-based authenticated encryption with a key, a message, and associated data. The following discusses in greater detail the encryption algorithm, cases as well as games used to discuss theory regarding these encryption algorithms. It can be appreciated that this disclosure is not limited in regard to these examples and “games”, however this is meant to provide greater detail of the encryption algorithms which may be used by the CCIP privacy system.

### Hash-Based Authenticated Encryption

### Preliminaries

When describing algorithms, x←y is used to denote that a variable x gets assigned the value of y, and x←s A(y) gets assigned the output of an execution of the randomized algorithm A on input y. If M∈{0, 1}* is a bitstring, then |M| denotes its length and [M]ₙ denotes the truncation of M to its leftmost n bits. The encoding of an integer m is denoted as an n-bit string as [symbol] m [symbol] ₙ.

The concatenation of two strings M₁ and M₂ is denoted M₁∥M₂. M₁∥M₂←splitₙ(M) is used to denote that M₁ is assigned the n leftmost bits of M, while M₂ is assigned the remaining rightmost bits of M; if |M|<n, then M₁ is assigned the entire message M while M₂ is the empty string.

### Definitions

We adapt the definitions for authenticated encryption as described in Dan Boneh and Victor Shoup, A Graduate Course in Applied Cryptography, Version 0.6. 2023. (available at https://cryptobook.us) to nonce-based authenticated encryption with associated data (AEAD).

An AEAD scheme Aε=(Kg, Enc, Dec) consists of a key generation algorithm that generates symmetric keys K←s Kg( ); an encryption algorithm C←s Enc(K, N, M, A) that, on input the key K, a nonce N, a message M, and associated data A, produces a ciphertext C and an integrity tag T; and a decryption algorithm M←Dec(K, N, A, C, T) that, on input the key, nonce, associated data, ciphertext, and tag outputs the message M, or reject to indicate that the tag was invalid. Correctness requires that for all keys K, messages M, nonces N, and associated data ADec(K, N, A, Enc(K, N, M, A))=M.

Privacy. The privacy property defines the confidentiality of the encrypted message M. Consider the following experiment

$$E {xp}_{A ε , A}^{priv - b}$$

with an adversary A for a given AEAD scheme Aε=(Kg, Enc, Dec) and b∈{0, 1}. The experiment starts by generating K←s Kg( ) The adversary A then repeatedly outputs two messages M_{i,0}, M_{i,1} of the same length |M_{i,0}|=|M_{i,1}|, together with a nonce Nᵢ and associated data Aᵢ, subject to the requirement that nonces are unique in the sense that Nᵢ≠+Nⱼ for all i≠j. The experiment computes Cᵢ←s Enc(K, M_{i,b}, Nᵢ, Aᵢ) and sends Cᵢ to A. Eventually, A outputs a bit b′∈{0, 1}. Let W_{b} be the event that A outputs b′=1 in

$$E {xp}_{A ε , A}^{p r i v - b} .$$

advantage of A in breaking the privacy of Aε is then defined as:

$$A d {v}_{A ε , A}^{p r i v} = \vert PR [ {W}_{0} ] - P R [ {W}_{1} ] \vert .$$

Ciphertext integrity. The ciphertext integrity guarantees that valid ciphertexts can only be created using the key K. Consider the experiment

$${Exp}_{A ℰ , A}^{c i}$$

that generates a key K←s Kg( ) and runs A without input. The adversary has access to an encryption oracle that, on input (Mᵢ, Nᵢ, Aᵢ), returns (Cᵢ, Tᵢ)←s Enc(K, Mᵢ, Nᵢ, Aᵢ), with the restriction that it can never make two queries i, j with the same nonce Nᵢ=Nⱼ. At the end of its execution, A outputs a ciphertext C, tag T, nonce N, and associated data A. The advantage

$${Adv}_{A ℰ , A}^{c i}$$

of A in breaking the ciphertext integrity of Aε is defined as the probability that Dec(K, N, A, C, T)≠reject and (C, T, N, A)=(Cᵢ, Tᵢ, Nᵢ, Aᵢ) for any i.

### Encrypt-then-MAC Scheme

Let H: {0, 1}*→{0, 1}ⁿ be a variable-input-length hash function modeled as a random oracle. Let r, k, [symbol] _{N}, [symbol] _{ctr}, [symbol] _{M}, [symbol] _{T}∈N such that r≥k+ [symbol] _{N}+ [symbol] _{ctr} and |M|< [symbol] .

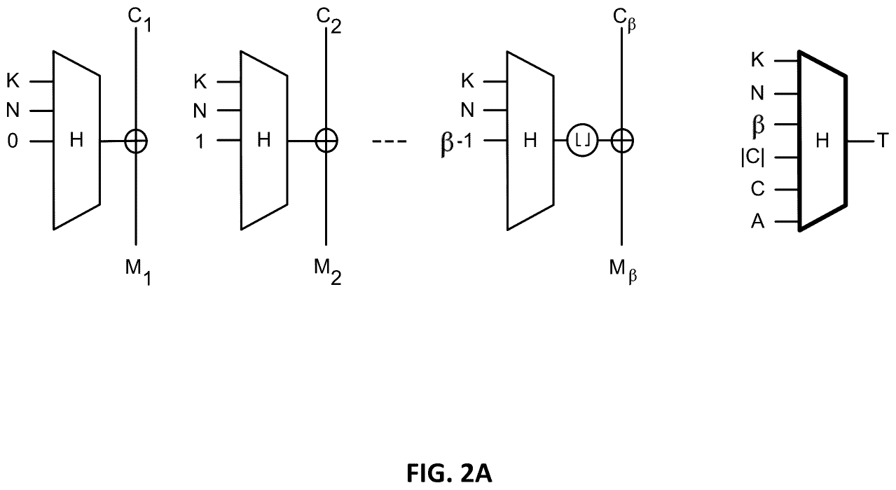

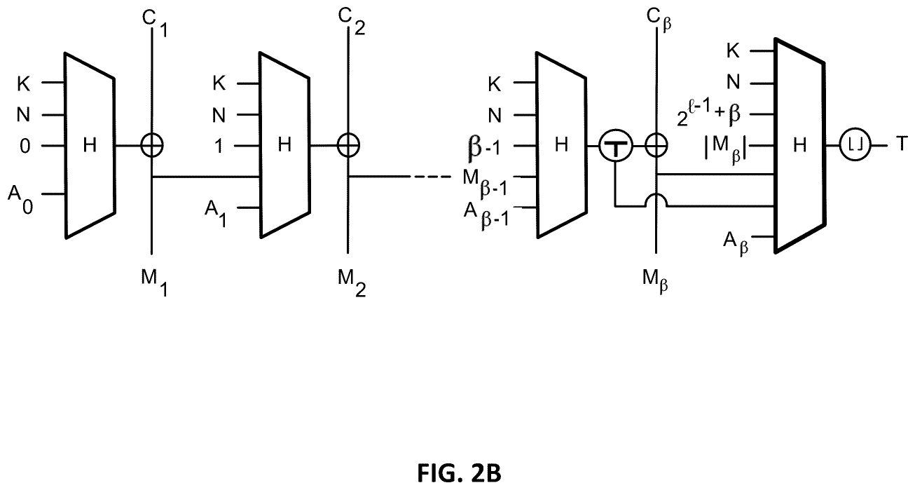

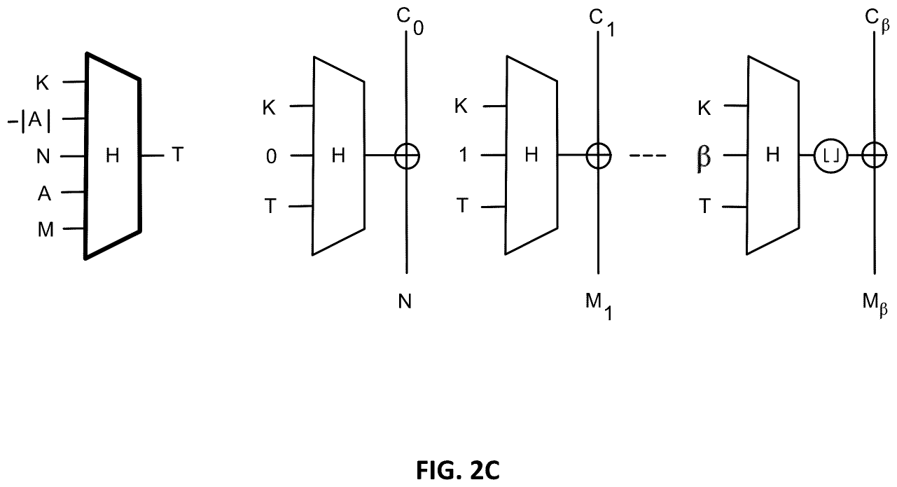

With reference to FIG. 2A, a graphical description of a simple hash-based authenticated encryption scheme is shown, in accordance with various embodiments. The thin-lined hash functions H comprise a fixed-length input of r bits, and the thick-lined hash functions comprise an arbitrary-length input. The following presents an authenticated encryption scheme associated with H, as depicted graphically in FIG. 2A.

Key generation K←s Kg( ): A random key is chosen, K←s{0, 1}^{k}.

Encryption (C, T)←Enc(K, N, M, A): On input a key K, a nonce N∈{0, 1 [symbol] , a message M, and associated data A, encryption proceeds as follows:

β ← ┌|M|/n|┐
for i = 1, . . . , β − 1 do
Mᵢ || M ← splitₙ(M)
Yᵢ ← H(K || N || [symbol] i − 1 [symbol] )
Cᵢ ← Mᵢ ⊕ Yᵢ
C ← C || Cᵢ
Yᵢ₊₁ ← H(K || N || [symbol] i [symbol] )
end for
M_{β} ← M
C_{β} ← M_{β} ⊕ └Y_{β}┘|M_{β}|
C ← C || Cβ
T ← └H(K || N || [symbol] β [symbol] || [symbol] |C| [symbol] || C || A)┘ [symbol]
return (C, T )

Decryption M←Dec(K, N, A, C, T): On input of the key K, nonce N, associated data A, ciphertext C and tag T, the decryption algorithm outputs a plaintext message M or a rejection symbol reject as follows:

β ← ┌|C|/n|┐
for i = 1, . . . , β − 1 do
Cᵢ || C ← splitₙ(C)
Yᵢ ← H(K || N || [symbol] − 1 [symbol] )
Mᵢ ← Cᵢ ⊕ Yᵢ
M ← M || Mᵢ
Yᵢ₊₁ ← H(K || N || [symbol] i [symbol] )
end for
C_{β} ← C
M_{β} ← C_{β} ⊕ └Y_{β} ┘_{|Cβ|}
M ← M || M_{β}
T′ ← └H(K || N || [symbol] β [symbol] ) || [symbol] |C [symbol] || C || A) [symbol]
if T′ = T then return M else return reject

### A More Efficient Scheme

### Construction

Let H: {0, 1}*→{0, 1}ⁿ be a variable-input-length hash function modeled as a random oracle. Let r, k, [symbol] _{N}, [symbol] _{ctr} [symbol] such that r≥k+ [symbol] _{N}+ [symbol] _{ctr}+n. The idea is that H is cheaper to evaluate for inputs up to r bits in length than for longer ones. For example, for the Keccak-256 hash function with pad10*1 padding, one would user=1600−512−2=1086 so that the message can be hashed using just a single evaluation of the Keccak-f permutation.

With reference now to FIG. 2B, a graphical description of the hash-based authenticated encryption scheme is shown, in accordance with various embodiments. The thin-lined hash functions H comprise a fixed-length input of r bits, and the thick-lined hash-functions comprise an arbitrary-length input. Consider the following authenticated encryption scheme associated with H, depicted graphically in FIG. 2B:

Key generation K←s Kg( ): Choose a random key K←s{0, 1}^{k}.

Encryption (C, T)←Enc(K, N, M, A): On input a key K, a nonce N∈{0, 1 [symbol] , a message M∈{0, 1}* with |M|≤n· [symbol] −1), and associated data A∈{0, 1}*, encryption proceeds as follows:

β ← ┌|M|/n┐
if β ≥ [symbol] then return reject [symbol]
_{A} ← r − k [symbol] _{N} − [symbol] _{ctr} − n
A₀ || A ← spli [symbol] (A)
Y₁ ← H(K || N || [symbol] 0 [symbol] || A₀)
for i = 1, . . . , β − 1 do
Mᵢ || M ← splitₙ(M )
Aᵢ || A ← spli [symbol] (A)
Cᵢ ← Mᵢ ⊕ Yᵢ
C ← C || Ci
Yᵢ₊₁ ← H(K || N || [symbol] i [symbol] || Mᵢ || Aᵢ)
end for
M_{β} ← M
Y_{β,L} || Yβ,R ← split_{|Mβ|} (Y_{β} )
C_{β} ← M_{β} ⊕ Y_{β,L}
C ← C || C_{β}
T ← └H (K || N || [symbol] + β [symbol] || [symbol] M_{β} | − 1 [symbol] || M_{β} || Y_{β,R} || A [symbol]
return (C, T )

Decryption M←Dec(K, N, A, C, T): On input of the key K, nonce N associated data A, ciphertext C and tag T, the decryption algorithm outputs a plaintext message M or a rejection symbol reject as follows:

β ← ┌|C|/n┐
if β ≥ [symbol] then return reject [symbol]
_{A} ← r − k − [symbol] _{N} − [symbol] _{ctr} − n
A₀ || A ← split [symbol] _{A+n}(A)
Y₁ ← H(K || N || [symbol] 0 [symbol] || A₀)
for i = 1, . . . , β − 1 do
Cᵢ || C ← splitₙ(C)
Aᵢ || A ← split [symbol] _{A}(A)
Mᵢ ← Cᵢ ⊕ Yᵢ
M ← M || Mᵢ
Yᵢ₊₁ ← H(K || N || [symbol] i [symbol] || Mᵢ || Aᵢ)
end for
C_{β} ← C
Y_{β,L} || Y_{β,R} ← split_{|Cβ|}(Y_{β})
M_{β} ← C_{β} ⊕ Y_{β,L}
M ← M || M_{β}
T′ └H (K || N || [symbol] + β [symbol] || [symbol] M_{β} | − 1 [symbol] _{┌log2n┐} || M_{β} || Y_{β,R} || A) [symbol]
if T = T′ return M else return reject

### Definitions

An NBE2 scheme consists of a deterministic encryption algorithm C Enc(K, N, A, M) that on inputs of: (1) the key K, randomly chosen from the key space {0, 1}k; (2) the nonce N∈{0, 1}*; (3) associated data A∈{0, 1}*; and (4) the message M∈{0, 1}*. The system may output a ciphertext C∈CS(|N|, |A|, |M|), and a decryption algorithm M←Dec(K, A, C) that on input of the key K, associated data A, and ciphertext C, returns the plaintext message M or reject to indicate that an error occurred. Correctness requires that Dec(K, A, Enc(K, N, A, M))=M for all K∈{0, 1}^{k}, all N∈{0, 1}*, all associated data A∈{0, 1}* and all messages M∈{0, 1}*. Security is defined through an experiment

$${Exp}_{A ℰ , A}^{nbe 2}$$

that chooses a random bit b←s {0, 1} and runs A with access to two oracles. If b=0, the experiment chooses a random key K←s {0, 1}^{k} and give A oracle access to an encryption oracle Enc(K·, ·, ·) and a decryption oracle Dec(K, ·, ·). If b=1, the adversary is given access to a random-bits oracle $(·, ·, ·) that, on input (N, A, M), returns a random ciphertext C←s CS(|N|, |A|, |M|), and a rejection oracle ⊥(·, ·) that, on input (A, M), returns reject. Here, we assume that A never queries its Enc(K, ·, ·, ·) or $(·, ·, ·) oracle twice on the same input (N, A, M), and that it never queries its Dec(K, ·, ·) or ⊥(·, ·) oracle on input (A, C) where C was the response of a previous oracle call Enc(K, ·, A, ·) or $(·, A, ·). These assumptions are without loss of generality because Enc is deterministic and because of the correctness requirement.

The advantage of A in breaking the NBE2 security of Aε is given by the equation

$${Adv}_{A ℰ , A}^{nbe 2} = \vert PR [ {A}^{E n c ( K , \cdot , \cdot , \cdot ) , Dec ( K , \cdot , \cdot )} ( ) = 1 ] - PR [ {A}^{\$ ( \cdot , \cdot , \cdot ) , ⊥ ( \cdot , \cdot )} ( ) = 1 ] \vert$$

### A Two-Pass Construction

Let H: {0, 1}*→{0, 1}ⁿ be a variable-input-length hash function modeled as a random oracle. Let [symbol] ∈ [symbol] be such that |A|< [symbol] and M< [symbol] n. For simplicity, the present discussion assumes that nonces are n-bit strings; if not, one can always turn them into one by applying a collision-resistant hash function, or use a slight modification described later.

With reference now to FIG. 2C, a graphical description of the two-pass NBE2 scheme is shown in accordance with various embodiments. The thin-lined hash functions H may comprise a fixed-length input of k+ [symbol] +n bits, and the thick-lined hash functions comprise an arbitrary-length input.

The following authenticated encryption scheme associated with H, depicted graphically in FIG. 2C can be seen as a variant of the synthetic IV (SIV) scheme of [RS06]:

Enc(K, N, A, M):
T ← H(K || [symbol] −|A| [symbol] || N || A || M)
β ← ┌|M |/n|┐
Y₀ ← H(K || [symbol] 0 [symbol] || T)
C₀ ← N ⊕ T₀ C ← C₀
for i = 1, . . . , β − 1 do
Mᵢ || M ← splitₙ(M)
Yᵢ ← H(K || [symbol] i [symbol] || T )
Cᵢ ← Mᵢ ⊕ Yᵢ
C ← C || Cᵢ
end for
M_{β} ← M
Y_{β} ← └H(K || [symbol] β [symbol] || T )┘_{|Mβ|}
Cᵢ ← Mᵢ ⊕ Yᵢ
C ← C || Cᵢ
return (C, T)
Dec(K, A, (C, T)):
β ← ┌|C|/n|┐ − 1
Y₀ ← H(K || [symbol] 0 [symbol] || T)
C₀ || C ← splitₙ(C)
N ← C₀ ⊕ Y₀ for i = 1, . . . , β − 1 do
Cᵢ || C ← splitₙ(C)
Yᵢ ← H(K || [symbol] i [symbol] || T) Mᵢ ← Cᵢ ⊕ Yᵢ
M ← M || Mᵢ
end for
C_{β} ← C
Y_{β} ← └H(K || [symbol] β [symbol] || T)┘|C_{β}|
Mᵢ ← Cᵢ ⊕ Yᵢ
M ← M || Mᵢ
T′ ← H(K || [symbol] −|A| [symbol] || N || A || M)
if T′ = T then return M else return reject

Theorem 1. Any adversary A making q_{H} random-oracle queries, q_{E} queries to its encryption or random-bit oracle, and q_{D} queries to its decryption or rejection oracle queries, has an advantage in breaking the NBE2 security of Aε of at most,

$${Adv}_{A ℰ , A}^{nbe 2} \leq \frac{{q}_{D} + {q}_{E}^{2}}{{2}^{n}} + \frac{{q}_{H}}{{2}^{k - 1}} .$$

Proof. To prove the theorem, we describe a sequence of games that gradually turn the NBE2 experiment for b=0 into that for b=1, i.e., gradually change A's view from A^{Enc(K, ·, ·, ·),Dec(K, ·, ·) to AS(·, ·, ·),⊥(·, ·)}. Let Gᵢ denote the event that A outputs 1 in Game i.

Game 0: This is the original nbe2 experiment for b=0, i.e., A is given oracles Enc(K, ·, ·, ·) and Dec(K, ·, ·). We have, Pr[G₀]=Pr[A^{Enc(K, ·, ·, ·),Dec(K, ·, ·)} ( )=1].

Game: 1 This game is identical to the previous game, except that the experiment aborts in the bad event B₁ that makes an explicit random-oracle query H(K∥ . . . ). Since K is only used as part of inputs to H, the outputs for which are chosen randomly from {0, 1}ⁿ, A's view is independent of K so that,

$$\begin{matrix}Pr [ {G}_{1} ] = Pr [ {G}_{0} ∧ {\underline{B}}_{1} ] \\ = Pr [ {G}_{0} \vert {\underline{B}}_{1} ] \cdot Pr [ {\underline{B}}_{1} ] \\ = Pr [ {G}_{0} ] - Pr [ {G}_{0} \vert {\underline{B}}_{1} ] \cdot Pr [ {\underline{B}}_{1} ] \geq Pr [ {G}_{0} ] - Pr [ {\underline{B}}_{1} ] \\ = Pr [ {G}_{0} ] - \frac{{q}_{H}}{{2}^{k}} .\end{matrix}$$

Above, the second line follows from the definition of conditional probability, the third holds because Pr[G₀]=Pr[G₀|B₁]·Pr[B₁]+=Pr[G₀|B₁]·Pr[B₁], the fourth from Pr[G₀|B₁]≤1, and the fifth because Pr[B₁]=q_{H}/2^{k}.

Game 2: In this game, we let the decryption oracle always return the rejection symbol reject, so that it behaves exactly like the rejection oracle ⊥(·, ·). This game is only different from the previous one in the event B₂ that A manages to submit at least one decryption query that doesn't reject. We bound A's probability of doing so through a case analysis.

In the following, let M and N be the message and nonce, respectively, reconstructed during a successful decryption query Dec(K, A, (C, T))≠reject. Also, let A's encryption oracle queries and responses be (Cᵢ, Tᵢ)←Enc(K, Nᵢ, Aᵢ, Mᵢ).

$$Case 1 : ( N , A , M ) \neq ( {N}_{i} , {A}_{i} , {M}_{i} ) for all i ∈ \{ 1 , … , {q}_{E} \} .$$

Let's consider the random-oracle query H(K∥ [symbol] −|A| [symbol] ∥N∥A∥M) that Dec performs to recompute the tag T′. Since (N, A, M)≠(Nᵢ, Aᵢ, Mᵢ), this query was never made by any encryption query. For each decryption query that makes, gets one guess T at the correct value T′; if T=T′, the response is reject. The probability that one of q_{D} queries makes a correct guess for T′ is therefore at most q_{D}/2ⁿ.

$$Case 2 : ( N , A , M ) = ( {N}_{i} , {A}_{i} , {M}_{i} ) for all i ∈ \{ 1 , … , {q}_{E} \} .$$

In this case, T=Tᵢ for decryption to succeed, which means that also the values Yᵢ=H(K∥ [symbol] i [symbol] ∥T) computed during decryption and the i-th encryption query are the same. Since N=Nᵢ it must hold that C₀=N⊕Y₀=C_{i,0}, and since Mⱼ=M_{i,j}, it must hold that Cⱼ=C_{i,j} for all blocks 1, . . . , β. We therefore have that (C, T)=(Cᵢ, Tᵢ) on top of A=Aᵢ, making this a decryption query that is not permitted by the experiment. We therefore have that,

$$Pr [ {G}_{2} ] \geq Pr [ {G}_{2} ] - \frac{{q}_{D}}{{2}^{n}} .$$

Game 3: This game is identical to Game 2, except that the experiment aborts in the event B₃ when the encryption oracle outputs at least two ciphertexts with the same tag, i.e., responds (Cᵢ, Tᵢ) to a query Enc(K, Nᵢ, Aᵢ, Mᵢ) and (Cⱼ, Tⱼ) to a query Enc(K, Nⱼ, Aⱼ, Mⱼ) such that Tᵢ=Tⱼ for i≠j. Because A never queries its encryption oracle twice on the same input, we know that (Nᵢ, Aᵢ, Mᵢ)≠(Nⱼ, Aⱼ, Mⱼ). The inputs to the random-oracle queries that compute Tᵢ←H(K∥ [symbol] −|Aᵢ [symbol] ∥Nᵢ∥Aᵢ∥Mᵢ) and Tⱼ←H(K∥ [symbol] −|Aⱼ| [symbol] ∥Nⱼ∥Aⱼ∥Mⱼ) must therefore also be different. Indeed, suppose they were the same, then we would have [symbol] −|Aᵢ| [symbol] ≠ [symbol] −|Aⱼ| [symbol] , Nᵢ=Nⱼ, and, because |Aᵢ|=|A|, A=Aⱼ and Mᵢ=Mⱼ.

The tags Tᵢ and Tⱼ were therefore chosen independently; the probability that any two encryption queries have colliding tags is,

$$PR [ {B}_{3} ] = \frac{{q}_{E} ( {q}_{E} - 1 )}{2 \cdot {2}^{n}} \leq \frac{{q}_{E}^{2}}{{2}^{n + 1}} .$$

The probability that A outputs 1 in this game is therefore

$$\begin{matrix}Pr [ {G}_{2} ] = Pr [ {G}_{2} ∧ {\underline{B}}_{3} ] \\ = Pr [ {G}_{2} \vert {\underline{B}}_{3} ] \cdot Pr [ {\underline{B}}_{3} ] \\ = Pr [ {G}_{2} ] - Pr [ {G}_{2} \vert {\underline{B}}_{3} ] \cdot Pr [ {\underline{B}}_{3} ] \geq Pr [ {G}_{2} ] - Pr [ {\underline{B}}_{3} ] \\ = Pr [ {G}_{2} ] - \frac{{q}_{E}^{2}}{{2}^{n + 1}} .\end{matrix}$$

Above, the second line holds by the definition of conditional probability, the third because Pr[G₂]=Pr[G₂|B₃]·Pr[B₃]+Pr[G₂|B₃]·Pr[B₃], the fourth because Pr[G₂|B₃]≤1, and the last by the earlier bound on Pr[B₃]. Note that the decryption oracle now behaves exactly like the rejection oracle ⊥(·, ·).

Game 4: In this game, we let the encryption oracle return random strings (C, T)←s {0, 1}^{n+|M|}×{0, 1}ⁿ of the appropriate length instead of real ciphertexts.

We established in the previous game that all tags Tᵢ in encryption responses are different. We therefore know that the inputs to the random-oracle queries Y_{i,j}←H(K∥ [symbol] j [symbol] ∥Tᵢ) are all different, and also that the inputs to the Y_{i,j} cannot collide with any tags Tₘ because the latter use negative values to encode [symbol] −|Aᵢ| [symbol] , which clearly separates them from the positive-signed inputs [symbol] j [symbol] [symbol] to Y_{i,j}. Because, moreover, A doesn't make any direct queries H(K∥ . . . ) since Game 1 and because the decryption oracle simply returns reject without making any random-oracle queries since Game 2, the Y_{i,j} are independent random strings that are only used once in the game, as part of a single encryption query. From A's view, the ciphertexts blocks C_{i,j}=M_{i,j}⊕Y_{i,j} are therefore uniformly random, so they can be replaced with random strings without any change to A's view.

Because (Nᵢ, Aᵢ, Mᵢ)≠(Nⱼ, Aⱼ, Mⱼ) for i≠j and because A doesn't make queries H(K∥ . . . ) directly, we also have that the tags Tᵢ=H(K∥ [symbol] −|Aᵢ| [symbol] ∥Nᵢ∥Aᵢ∥Mᵢ) are random strings from the view of A.

In summary, the ciphertexts can be replaced with random strings without any changes to A's view, i.e., Pr[G₄]=Pr[G₃]. Note that now also the encryption oracle behaves exactly like the random-bits oracle $(·, ·, ·).

Game 5: This game reverses the changes made in Games 1 and 3, i.e., it no longer aborts in the event B₁ that A makes a query H(K∥ . . . ) or B3 that two encryption responses have the same tag. We have that,

$$PR [ {G}_{5} ] \geq Pr Pr [ {G}_{4} ] - \frac{{q}_{H}}{{2}^{k}} - \frac{{q}_{E}^{2}}{{2}^{n + 1}} .$$

Notice that now the game is exactly the nbe2 experiment for the case b=1, i.e., Pr[G₅]=Pr[A^{S(·, ·, ·),⊥(·, ·)}( )=1]. The theorem statement follows from summing up the equations above and the fact that

$${Adv}_{A ℰ , A}^{nbe 2} = \vert PR [ {G}_{0} ] - Pr [ {G}_{5} ] \vert .$$

The term

$${q}_{E}^{2} / {2}^{n}$$

in the above theorem implies that n needs to be chosen of collision-resistant length, e.g., n=256. (Even if one could argue that we don't need full collision-resistance length for n because, realistically, q_{E}<<q_{H}, as each encryption requires interaction with the sender while hashes can be performed offline. Still, if we want an adversary with access to q_{E}=240 ciphertexts to have advantage at most 2⁻⁶⁴, we would need n=144.) This has an effect on the tag length and therefore on the ciphertext expansion.

An alternative construction would be to truncate the tag length to T←└H(K∥ [symbol] −|A| [symbol] ∥N∥A∥M) [symbol] , and include the nonce N as well as the tag T in the inputs to the stream cipher, i.e., Yᵢ←H(K∥ [symbol] i [symbol] ∥N∥T). A more fine-grained analysis that distinguishes between the overall number of encryption queries q_{E} and the maximal number of encryption queries made with the same nonce q_{N}=max_{N∈{0,1}}ⁿ|{(N, Aᵢ, Mᵢ)}| would point out that the adversary's advantage for this alternative construction is,

$${Adv}_{A {ℰ}^{′} , A}^{nbe 2} \leq \frac{{q}_{D} + {q}_{N}^{2}}{{2}^{l} T} + \frac{{q}_{H}}{{2}^{k - 1}} .$$

Since nonce misuse should be relatively rare, one could for example take q_{N}=2¹⁰, allowing for a shorter tag length of [symbol] _{T}=128 bits.

### A Single-Pass Construction

### A Public-Key, Proof-of-Encryption Protocol

This section introduces an encryption protocol which provides zero-knowledge “proof of encryption” without revealing any encryption keys. In exemplary embodiments it may be utilized as follows:

The context of this disclosure is to present a way for blockchains to use CCIP as a transport layer for encrypted messages, preserving the confidentiality of those messages from CCIP. It would be much easier to track accountability for use and leakage of private keys if all encryption/decryption occurred off-chain, while still allowing for on-chain visibility into the message CCIP is to transport.

The above symmetric schemes require that the encryption/authentication key be sent in the clear to the smart contract. This may limit their use I practice, as it may be important that to the functionality of blockchains on which the contract is deployed are visible to entities which should not share the capabilities enabled by the symmetric keys. Such visibility may be important for accountability between the parties using the blockchains, for instance.
1. Off-chain agent sends to contract C plaintext M, ciphertext C←s Eₚₖ(M), plus zero-knowledge proof π that C is a valid encryption of M.
2. C validates (π, M, C), processes M, and emits an event E containing (C, π).
3. CCIP responds to E, sending message containing (C, π) to recipient contract on another blockchain, which generates another event F containing (C, π).
4. Off-chain agent responds to F by decrypting C to recover M using the secret key sk associated with the public key pk under which C was encrypted, and sends (π, M, C) on-chain to D.
5. D verifies that (π, M, C) corresponds to a CCIP message it's received. validates (π, M, C), and processes M.

An exemplary construction is as follows (based on El Gamal). Let ε be a cryptographic elliptic curve with generator g∈ε (group operation in additive notation), pk∈ε a public key to encrypt to, pk′ a public key owned by the sender and known by the receiver, and M a message to be encrypted. Let n be a number of bits less than 256, such that 2⁻ⁿ is an “effectively impossible” probability. E.g. n=64 would do, but exemplary embodiments may be able to use a lower value. (This value is desirably defined at the protocol level, and is not message-dependent, in order to avoid leaking information about the message.). Break M into blocks (Mᵢ)ᵢ of 256−n bits. For each Mᵢ, iterate through xᵢⱼ=Mᵢ∥ [symbol] j [symbol] ₙ for j=0, . . . , 2ⁿ−1 until xᵢⱼ represents the x-ordinate of a point Pi∈ε. For each Mᵢ, sample uniformly and securely rᵢ←s{0, . . . , [ε]−1}. C=((rᵢ·g, rᵢ·pk+Pᵢ))ᵢ.

The proof π is a zero-knowledge proof of knowledge of the rᵢ's such that if Cᵢ=(pᵢ₁, pᵢ₂), pᵢ₁=rᵢ·g and pᵢ₂=rᵢ·pk+Pᵢ. If ε has a pairing e: ε×ε′→T, the contents of π can be, π=Σᵢ aᵢ·(rᵢ·g′)∈ε′, where the ai's are sampled according to the Fiat-Shamir heuristic on (C, pk, (Pᵢ)ᵢ), and g′ is the generator of ε′. Then π can be verified by checking, e((Σᵢ aᵢ),g′)=e(g, π) and e((Σᵢ αᵢ·(pᵢ₂−Pᵢ),g′)=e(pk,π). (These can be combined into a single pairing check by a further linear combination with Fiat-Shamir coefficients.)

Working with a pairing-capable curve has many advantages, but the one provided by the EVM is currently estimated to only provide at most 100 bits of security, and the attack on it is still relatively undeveloped. In light of this, exemplary embodiments can operate on secp256k1, and use a Schnorr zero-knowledge proof of knowledge of discrete log instead. Because the EVM provides no precompiles for secp256k1, the values aᵢ·pᵢ₁ and aᵢ·(pᵢ₂−Pᵢ) are passed into contracts C and D and verified using the Vitalik's ecrecover trick. Given a Fiat-Shamir-sampled coefficient z, set b=g+z·pk and h=(Σᵢ aᵢ·pᵢ₁)+z·(Σᵢ aᵢ·(pᵢ₂−Pᵢ)), we can prove knowledge of x=log_{b}h in a single step: sample r←${0, . . . |ε|−1}, set u=r·b, c=H(b, h, u), w=r+cx, and π=(u, w).

This proof is verified by computing c=H(b, h, u) and checking that w·b=u+c·h.

Finally, the encryptor constructs a signature σ on (C, π) with pk′, and (C, π, σ) are transmitted to CCIP by an event.

On receipt of (C, π, σ) by the destination contract, it checks σ, and emits an event (C, π, σ) which is processed by the off-chain agent. The off-chain agent uses knowledge of the discrete log pk=sk·g to recover M, constructs the auxiliary information the on-chain contract needs to verify M against (C, π), and sends those on-chain. D verifies M against (C, π), and processes M.

In addition to all the foregoing, principles of the present disclosure may be compatible with, complimentary to, and/or utilized in connection with principles set forth in:
U.S. Ser. No. 16/553,292 filed Aug. 28, 2019, entitled “Systems, Methods, and Storage Media for Interfacing At Least One Smart Contract Stored on A Decentralized Architecture With External Data Sources,” now U.S. Pat. No. 11,854,101;
U.S. Ser. No. 17/471,035 filed on Sep. 9, 2021, entitled “Computer Network Transaction Sequencing Method and System”;
U.S. Ser. No. 17/678,769 filed on Feb. 23, 2022, entitled “Method and Apparatus for Providing Secure Information to a Decentralized Computing Environment”;
U.S. Ser. No. 18/207,888 filed on Jun. 9, 2023, now U.S. Patent Application Publication No. 2023-031885 entitled “Method and Apparatus for Producing Verifiable Randomness Within a Decentralized Computing Network”;
PCT Application No. PCT/IB2025/057076 filed Jul. 12, 2025, and entitled “Cross-Chain Interoperability Protocol”;
PCT Application No. PCT/IB2025/057077 filed on Jul. 12, 2025, and entitled “Systems and Methods for Risk Management Networks”; and
U.S. Provisional Patent Application No. 63/874,539 filed on Sep. 2, 2025, and entitled “Secure Runtime Environment for Blockchain Application Development and Deployment.”

The contents of each of the foregoing applications are incorporated herein by reference, but except for any subject matter disclaimers or disavowals, and except to the extent that the incorporated material is inconsistent with the express disclosure herein, in which case the language in this disclosure shall control.

For the sake of brevity, conventional database management, network communication, computer networking, data compression, error checking, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical connections may be present in a practical system of consensus or related methods.

While the description references specific technologies, system architectures and data management techniques, practitioners will appreciate that this description is of various exemplary embodiments, and that other devices and/or methods may be implemented without departing from the scope of principles of the present disclosure.

While the steps outlined herein represent exemplary embodiments of principles of the present disclosure, practitioners will appreciate that there are many suitable computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods, and computer program products are provided. In the detailed description herein, references to “various exemplary embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

For example, the steps recited in any of the method or process descriptions may be executed in any suitable order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed. Cir. 2008)). For example, the description or claims may refer to a processor for convenience, but principles of the disclosure contemplate that the processor may be multiple processors. The multiple processors may handle separate tasks or combine to handle certain tasks. Although specific advantages have been enumerated herein, various exemplary embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A cross-chain interoperability protocol privacy device, comprising one or more processors configured by machine-readable instructions to:
encrypt a cleartext transaction to an encrypted transaction;
read, by a decentralized oracle network, the encrypted transaction from a first chain;
provide, by the decentralized oracle network, the encrypted transaction to a second chain; and
decrypt the encrypted transaction based on a decryption key.

2. The device of claim 1, wherein the instructions are further configured to:
determine, by the decentralized oracle network, an attested root based on the encrypted transaction;
provide, by the decentralized oracle network, the attested root to the second chain;
determine, by the decentralized oracle network, a proof verification based on the attested root and the encrypted transaction; and
provide, by the decentralized oracle network, the encrypted transaction and the proof verification to the second chain.

3. The device of claim 1, wherein the encrypting the cleartext transaction is encrypted on the first chain based on an encryption key to create the encrypted transaction.

4. The device of claim 3, where the encryption key of the first chain and the decryption key of the second chain are the same symmetric encryption key.

5. The device of claim 3, wherein the encryption key of the first chain is a public encryption key, and wherein the decryption key of the second chain is a private decryption key.

6. The device of claim 1, wherein the instructions are further configured to:
provide, by the decentralized oracle network and to the second chain, an attested root of a batch of transactions, wherein the batch of transactions comprises one or more encrypted transactions and one or more non-encrypted transactions; and
provide, by the decentralized oracle network and to the second chain, a portion of the batch of transactions and a proof verification, wherein the proof verification is based on a proof that the portion of the batch of transactions was used to produce the attested root.

7. The device of claim 1, wherein the instructions are further configured to:
read, by the decentralized oracle network, the encrypted transaction from one or more proxy node machines associated with the first chain; and
provide, by the decentralized oracle network, the encrypted transaction to one or more proxy node machines associated with the second chain.

8. The device of claim 7,
wherein the one or more proxy node machines associated with the first chain reads the cleartext transaction and encrypts the cleartext transaction based on an encryption key, and
wherein the one or more proxy node machines associated with the second chain receives the encrypted transaction, and decrypts the encrypted transaction based on the decryption key.

9. The device of claim 8, wherein the encryption key of the one or more proxy node machines associated with the first chain and the decryption key of the one or more proxy node machines associated with the second chain are the same symmetric encryption key.

10. The device of claim 8, wherein the encryption key of the one or more proxy node machines associated with the first chain is a public encryption key, and wherein the decryption key of the one or more proxy node machines associated with the second chain is a private decryption key.

11. A method of cross-chain interoperability protocol privacy, the method comprising:
encrypting a clear-text transaction to an encrypted transaction;
reading, by a decentralized oracle network, the encrypted transaction from a first chain;
providing, by the decentralized oracle network, the encrypted transaction to a second chain; and
decrypting, by the second chain, the encrypted transaction based on a decryption key.

12. The method of claim 11, further comprising:
determining, by the decentralized oracle network, an attested root based on the encrypted transaction;
providing, by the decentralized oracle network, the attested root to the second chain;
determining, by the decentralized oracle network, a proof verification based on the attested root and the encrypted transaction; and
providing, by the decentralized oracle network, the encrypted transaction and the proof verification to the second chain.

13. The method of claim 11, wherein the encrypting the cleartext transaction is encrypted on the first chain based on an encryption key to create the encrypted transaction.

14. The method of claim 13, wherein the encryption key of the first chain and the decryption key of the second chain are the same symmetric encryption key.

15. The method of claim 13, wherein the encryption key of the first chain is a public encryption key, and wherein the decryption key of the second chain is a private decryption key.

16. The method of claim 11, further comprising:
providing, by the decentralized oracle network and to the second chain, an attested root of a batch of transactions, wherein the batch of transactions comprises one or more encrypted transactions and one or more non-encrypted transactions; and
providing, by the decentralized oracle network and to the second chain, a portion of the batch of transactions and a proof verification, wherein the proof verification is based on a proof that the portion of the batch of transactions was used to produce the attested root.

17. The method of claim 11, further comprising:
reading, by the decentralized oracle network, the encrypted transaction from one or more proxy node machines associated with the first chain; and
providing, by the decentralized oracle network, the encrypted transaction to one or more proxy node machines associated with the second chain.

18. The method of claim 17, wherein the one or more proxy node machines associated with the first Chain 1 reads the cleartext transaction from Chain 1 and encrypts the cleartext transaction based on an encryption key, and
wherein the one or more proxy node machines associated with the second chain receives the encrypted transaction, and decrypts the encrypted transaction based on the decryption key.

19. The method of claim 18, where the encryption key of the one or more proxy node machines associated with the first chain and the decryption key of the one or more proxy node machines associated with the second chain are the same symmetric encryption key.

20. The method of claim 18, wherein the encryption key of the one or more proxy node machines associated with the first chain is a public encryption key, and wherein the decryption key of the one or more proxy node machines associated with the second chain is a private decryption key.

21. A cross-chain interoperability protocol privacy system, comprising:
a processor; and
a tangible, non-transitory memory configured to communicate with the processor, the tangible, non-transitory memory having instructions stored thereon that, in response to execution by the processor, cause the processor to perform operations comprising:
encrypting, on a first chain, a clear-text transaction to an encrypted transaction;
reading, by a decentralized oracle network, the encrypted transaction from the first chain;
determining, by the decentralized oracle network, an attested root based on the encrypted transaction;
providing, by the decentralized oracle network, the attested root to a second chain;
determining, by the decentralized oracle network, a proof verification based on the attested root and the encrypted transaction;
providing, by the decentralized oracle network, the encrypted transaction and the proof verification to the second chain; and
decrypting, by the second chain, the encrypted transaction based on the proof verification and a decryption key.
